(19) United States
(12) Patent Application Publication
(10) Pub. No.: US 2010/0057642 A1
(43) Pub. Date: Mar. 4, 2010

(54) Treasure hunt' business stimulator

(76) Inventor: Stu Rasmussen, Silverton, OR (US)

Correspondence Address: STU RASMUSSEN, 417 N. WATER STREET, SILVERTON, OR, 97381, US

(21) Appl. No.: 12/584,216

(22) Filed: Sep. 1, 2009

Related U.S. Application Data
(60) Provisional application No. 61/190,886, filed on Sep. 2, 2008.

(51) Int. Cl. G06Q 90/00

(52) U.S. Cl. 705/500

(57) ABSTRACT

A method of creating an advertising campaign of the ‘Treasure Hunt’ variety which has the appearance of a sweepstakes is disclosed. The method is unique in that unlike a sweepstakes, no element of chance is involved and all participants are winners. In operation, individually identifiable entry certificates, coupons or other tokens are distributed to a target audience universe through any of several means such as direct mail, inclusion in printed periodicals or via on-line distribution. Recipients are advised that their entry form is definitely a winner at one of a number of participating business locations which are geographically proximate or otherwise accessible to the recipient. Each participating business is supplied with a list of the identification data of the distributed entry certificates which are winners at their location, and various levels of prizes may be awarded.

### CROSS REFERENCE TO RELATED APPLICATIONS

This application is entitled to the benefit of Provisional Patent Application Ser. No. 61/190,886 filed 2008-09-02.

### BACKGROUND

1. Field of the Invention

This invention relates generally to methods of direct-response advertising using printed or otherwise publicly distributed media.

2. Description of Prior Art

Finding, acquiring and retaining customers for retail and commercial businesses is an ongoing challenge. Advertising methods attempting to accomplish this result are many and varied. With the advent of the Internet, traditional ‘brick and mortar’ retail businesses have been adversely impacted by redirection of consumers away from these traditional retail establishments.

Many ‘Sweepstakes’, ‘Lucky Number’ and “Treasure Hunt” advertising methods have been implemented, generally configured as distributing numbered or otherwise identifiable tokens to a universe of potential customers to entice them to visit or otherwise interact with a merchant to see if their number is a ‘winner’. A typical embodiment of this is found in U.S. Pat. No. 4,601,490 issued to Brandon for a “Multi-coupon sweepstakes promotion vehicle” and there are dozens of other similar inventions, both patented and in the public domain, which do not offer the advantage and singularity of my invention.

### SUMMARY

My invention is a new and novel advertising method, which stimulates customers to actively and personally visit many discrete ‘brick and mortar’ business establishments by offering prizes, discounts or other incentives through distributed media such as direct mail, periodicals or via the Internet. Implementing my invention, advertising can truthfully state that “Every Number is a Winner” and participating merchants can expect to see large numbers of ‘Lucky Number’ participants passing through their establishments, thereby enhancing traffic, introducing new potential customers and encouraging new sales.

While this new method has the appearance of a ‘sweepstakes’ to the recipient, there is no element of chance in the operation of the advertising method so it is not subject to gaming or sweepstakes regulation.

### OBJECTS AND ADVANTAGES

The objects of my invention are to provide an effective advertising vehicle for ‘brick and mortar’ merchants and a fun experience for the participants. This is accomplished by offering a guarantee to each advertising recipient that the ‘Lucky Number’ they received is a ‘Winner’ at one of the participating merchants. Rather than being disappointed at losing, the recipient gets the satisfaction of definitely being a winner—somewhere.

One advantage of my invention over existing similar advertising schemes is that my invention can be used by more than one advertising merchant simultaneously—in fact it adds to the efficacy of the advertising program. “The more, the merrier”. This allows multiple independent advertisers who are geographically proximate to pool their advertising resources and get better and more cost-effective penetration into the target market area.

An additional advantage of my invention is that it uniquely appeals to the advertising recipient through the assurance that the advertising piece he received is guaranteed to be a winner. This incentivizes them to participate in the ‘Treasure Hunt’ to see where their ‘Winning Number’ certificate can be redeemed for an item of value or prize.

An additional advantage of my invention is the potential re-use of the “Lucky Number” information distributed to the universe of recipients. This gives the appearance to the recipient of a much greater chance of winning than a 1-for-1 correlation of the receiver universe to the number of prizes available would exhibit.

### DRAWING FIGURES

No drawings are included.

### REFERENCE NUMERALS IN DRAWINGS

Not Applicable.

### DESCRIPTION

My “Treasure Hunt” invention works thusly: Some number ‘A’ of participating advertisers agrees to participate in the Treasure Hunt by offering game prizes in the form of merchandise, discounts or cash to treasure hunt participants. Each advertiser may determine what prize or prizes is to be offered to the participants from their location. Ideally, each advertiser will offer one “Grand Prize” of considerable perceived value, optionally a smaller number of “Second Prizes” of a lesser perceived value and agrees to provide “Third Prizes” of token value to the remaining winning game participants as describe subsequently. A number N (representing the universe of prospective advertising recipients) of advertising pieces are generated by conventional means such as printing, lithography, web page, etc.; each of which is serially numbered or otherwise more-or-less uniquely identified. If the target audience N is say 10,000 homes, then 10,000 serially numbered coupons, certificates, mailers or other device are produced.

Each of these advertising devices is guaranteed to be a ‘winner’ in the Treasure Hunt through the following method:

A number of “Grand Prize” winning numbers equal to the number of participating advertisers ‘A’ is selected from the universe of serial numbers distributed to the target audience N. One of each of these ‘winning numbers’ is assigned to one of the participating advertisers.

Optionally, a larger number of “Second Prize” winning numbers is selected from the universe of serial numbers distributed to the target audience ‘N’. Generally there are ‘X’ times ‘A’ numbers selected for second prizes, where ‘A’ is the number of participating advertisers and ‘X’ is the number of “Second Level” prizes the advertisers have agreed to provide.

The remaining serial numbers in the target universe after the Grand and Second prize winners are removed are the ‘Third Place” or “Runner Up” winners in the Treasure Hunt. Each participating advertiser is provided with a poster, printed sheet or other form of winner data which includes a listing of their Grand Prize winning Number, any ‘Second Prizes” winning numbers assigned and a listing of all “Third Prize” or “Runner Up” winning numbers at their establishment.

The Grand and Second Prize winning numbers are determined as described above. The Third place or ‘runner up’ winners are randomly distributed among the advertisers so that each advertiser receives approximately N divided by A third place winners, and none of the numbers appears on more than one advertiser's list of winners.

In operation, the advertising message with the ‘winning number’ attached is distributed to the target audience by mail, as a newspaper or periodical insert or other method. The message includes the “Treasure Hunt” rules, prominent of which is that “Every Number is a WINNER”. Optionally, individual advertising messages from the participating advertisers are included in the advertising message. At the very least, it should include the names and addresses of the participating merchants so that ‘Treasure Hunters” know where to do their hunting.

Members of the target audience subsequently bring their numbered treasure hunt tickets to the participating advertisers and check on each advertiser's listing whether the hunter is a winner at that establishment or not.

It is guaranteed that every number is a winner SOMEWHERE, and the ‘treasure hunt’ participant is encouraged to hunt through the advertisers to find where they are a winner and collect their prize.

If a large universe of advertising recipients is anticipated, the quantity of numbers in the array can be reduced to give the recipient a sense that his/her chances of winning are greater. For example, if a distribution of 200,000 advertising pieces is planned, the range of numbers issued could be limited to 1,001 to 9,999. After the individual merchant Grand- and Second-prize winners are extracted from that group, the remaining numbers can be distributed to the universe of 200,000 by re-using the third- or ‘runner up’ multiple times. In the case of 200,000 recipients and 1,001 to 9,999 desired number range, each number would be issued about 23 times.

There are security requirements outside the scope of this application that may be needed to prevent cheating by insiders, but these methods are well known and do not need further explanation.

### CONCLUSION, RAMIFICATIONS, AND SCOPE

Accordingly, the reader will see that the invention provides a novel means for a group of advertisers to enhance the efficiency of their advertising while sharing the cost of the promotion among themselves and giving their customers and potential customers a fun and satisfying bit of entertainment and diversion by participating in the treasure hunt since each and every player is guaranteed to be a winner.

Although the descriptive information provided above contains many specificities, these should not be construed as limiting the scope of the invention but as merely providing illustrations of some of the presently developed or preferred embodiments of the invention. The claims describe a general method of producing the sweepstakes numbers and distribution, but variations in the software algorithm which could be applied to the operation of the invention are readily imagined and implemented. Thus the scope of the invention should be determined by the appended claims and their legal equivalents rather than by the examples given.

What is claimed is:

1. A method for creating a ‘Sweepstakes’, ‘Lucky Number’ or “Treasure Hunt” advertising promotion campaign comprising the steps of:
producing individual uniquely identifiable, through printed serial numbering or other means, advertising certificates or coupons,
and concurrently creating two or more ‘winner listings’, each containing a subset of the identification data of the aforementioned certificates,
and taken as a whole the group of ‘winner listings’ includes each and every one of the unique identifiers of the universe of advertising certificates at least once;
and said uniquely identifiable advertising certificates or coupons are then distributed to a target audience via any available transfer medium.

2. The method of creating an advertising campaign in claim 1 including a method of appending to each coupon a means of verifying the authenticity of the coupon through inclusion of a calculated checksum or other verification process.
